(19) United States
(12) Patent Application Publication
(10) Pub. No.: US 2013/0269498 A1
(43) Pub. Date: Oct. 17, 2013

(54) Composite Cutting Blade

(71) Applicants: Adam R. Loukus, Calumet, MI (US); Josh E. Loukus, Calumet, MI (US); David M. Somero, New Ipswich, NH (US); Niel S. Somero, New Ipswich, NH (US); Nathan K. Somero, New Ipswich, NH (US); David W. Somero, New Ipswich, NH (US)

(72) Inventors: Adam R. Loukus, Calumet, MI (US); Josh E. Loukus, Calumet, MI (US); David M. Somero, New Ipswich, NH (US); Niel S. Somero, New Ipswich, NH (US); Nathan K. Somero, New Ipswich, NH (US); David W. Somero, New Ipswich, NH (US)

(21) Appl. No.: 13/793,305

(22) Filed: Mar. 11, 2013

Related U.S. Application Data
(63) Continuation of application No. PCT/US2012/033167, filed on Apr. 11, 2012.

(51) Int. Cl. B23D 61/02; B23D 65/00

(52) U.S. Cl. CPC B23D 61/028; B23D 65/00
USPC 83/676; 76/112

(57) ABSTRACT

In some cases a composite cutting blade includes one or more cutting segments along a periphery of a hub segment. According to an example, the hub segment and the one or more cutting segments can comprise the same or different porous material. A metallurgical bond between the one or more cutting segments and the hub segment is created by a metal which infiltrates the porous material of both segments. The one or more cutting segments also include a cutting material which at least partially defines a cutting edge and/or a cutting surface of each cutting segment extending along the periphery of the composite blade.

### CROSS-REFERENCE TO RELATED APPLICATIONS

This is a continuation of International Application No. PCT/US2012/033167 filed Apr. 11, 2012, which claims priority to U.S. Provisional Patent Application Ser. No. 61/516,931 filed Apr. 11, 2011, the contents of each of which are hereby incorporated herein by reference.

### BACKGROUND

This disclosure generally relates to cutting and/or grinding devices and blades used for cutting and/or grinding, and more particularly relates to cutting blades having a composite structure.

Heavy-duty and/or high-performance saws and saw blades for cutting hard and/or reinforced materials are well known. Such types of blades can be useful for cutting materials such as concrete, which may include several reinforcing materials such as aggregate and rebar. One type of well-known high-strength saw blade is a diamond blade. A diamond blade generally includes a circular steel disc with a diamond bearing edge. The diamond bearing edge is often formed from a mixture of diamonds and metal powders which are pressed and sintered to form a solid metal alloy in which the diamonds are suspended. The diamond bearing edge (or portions thereof) are usually securely attached to the steel core with a mechanism such as brazing or laser welding.

While a diamond bearing edge such as that described above is a relatively good thermal conductor, the steel disc is a relatively poor thermal conductor. As such, when the edge heats up during operation, it is often times difficult to rapidly dissipate (or remove) the heat away from the cutting interface. This results in a build-up of heat which can cause the steel disc to warp and/or buckle, and renders the blade useless even though the cutting edge may still have a significant portion of its useful life remaining

Some attempts to extend the useful life of a blade involve attempting to rapidly remove or dissipate the significant amount of heat typically generated at the cutting interface during operation. In some applications, a steady stream of relatively cool water or oil is provided at the interface between the blade and the material that is being cut and/or ground. However, even such measures prove inadequate for certain applications and/or under certain operating conditions.

### SUMMARY

Some embodiments generally provide composite cutting blades and methods of manufacturing such blades. According to some embodiments of the invention, a composite blade includes one or more cutting segments extending along a periphery of a hub segment. The hub segment includes one or more recesses adjacent its periphery, wherein each one of the one or more recesses is configured for receiving at least a portion of at least one of the one or more cutting segments. The hub segment and each one of the one or more cutting segments received within at least one of the one or more recesses are metallurgically bonded. Each one of the one or more cutting segments may include a cutting material and a first porous material, and the hub segment may include a second porous material which is different from or the same as the first porous material. A molten metal infiltrates the voids (or pores) of both the first and the second porous material, and creates a metallurgical bond between at least portions of the first and the second porous material, i.e., between at least portions of the hub segment and the one or more cutting segments received within the one or more recesses of the hub segment.

According to some embodiments, a composite blade includes one or more cutting segments along a periphery of a hub segment. The hub segment includes a first porous material that is at least partially infiltrated by a metal. The hub segment and each one of the one or more cutting segments are metallurgically bonded. In some embodiments, each one of the one or more cutting segments includes a cutting material and a second porous material that is at least partially infiltrated by the metal. The second porous material may be the same as or different from the first porous material. The metallurgical bond is formed at least partially by the metal within both the hub segment and each one of the one or more cutting segments.

According to some embodiments, a method of manufacturing a composite blade includes several steps, some of which may be performed in parallel while others may be performed sequentially. The manufacturing starts with providing one or more cutting segment preforms, each at least partially defining a cutting segment of the composite blade. Each one of the one or more cutting segment preforms include a cutting material and a first porous material. A hub preform, which at least partially defines a hub segment of the composite blade is also provided. The hub preform includes a second porous material and one or more recesses adjacent its periphery. Each recess in the hub preform is configured for receiving at least a portion of each one of the one or more cutting segment preforms. Then, a blade preform is assembled by positioning at least a portion of each one of the one or more cutting segment preforms within at least one of the one or more recesses in the hub preform. Next, the blade preform is positioned within a die cavity and molten metal is introduced into the die cavity. The molten metal at least partially infiltrates both the hub preform and each one of the one or more cutting segment preforms, and creates a metallurgical bond between at least a portion of the hub segment and at least the portion of each one of the one or more cutting segments received within the one or more recesses in the hub preform.

In some embodiments, the cutting segment preforms, and thus the cutting segments as well, include a first porous material and a cutting material (e.g., diamond particles). In some embodiments the hub preform, and thus also the hub segment, includes a second porous material and a reinforcing material (e.g., ceramic fibers and/or particles). In some embodiments, one or both of the first and the second porous material are a ceramic material. In some embodiments, the first porous material and/or the second porous material are a ceramic material including silicon carbide. In some cases, the first porous material in the cutting segment preform has a volume fraction between approximately 40% by volume and approximately 65% by volume. In some cases the second porous material in the hub segment preform has a volume fraction between approximately 10% by volume and approximately 50% by volume.

In some embodiments, at least a portion of each one of the one or more cutting segments includes at least one cutting edge and/or cutting surface which are/is at least partially defined by the cutting material.

Some embodiments may optionally provide none, some, or all of the following advantages, though other advantages not listed here may also be provided. In some cases, the composite blade is configured for removing heat away from the cutting edge and dispensing it at a rate substantially faster than prior art cutting blades. In some cases, this can provide a composite blade with an extended life cycle. In some embodiments, the hub segment and each cutting segment are fixedly attached to one another by the metallurgical bond which eliminates or reduces separation during operation. In certain cases, an infiltrated metal enhances the structural integrity, including the strength and stiffness, of the composite blade. The composite blade, in some embodiments of the invention, operates at a decreased noise level relative to prior art cutting blades.

These and various other features and advantages will be apparent from a reading of the following detailed description.

### BRIEF DESCRIPTION OF THE DRAWINGS

The following drawings illustrate particular embodiments and therefore do not limit the scope of the invention. The drawings are not to scale (unless so stated) and are intended for use in conjunction with the explanations in the following detailed description. Embodiments of the present invention will hereinafter be described in conjunction with the appended drawings, in which

FIG. 1A is a perspective view of a composite blade in accordance with an embodiment;

FIG. 1B is a partial cross-sectional view along line A-A of the composite blade of FIG. 1A;

FIG. 2 is a flow chart illustrating a method of manufacturing a composite blade in accordance with some embodiments;

FIG. 3A is a perspective view of a partially assembled blade preform in accordance with an embodiment;

FIG. 3B is a partial cross-sectional view of the hub preform of FIG. 3A taken along line B-B in FIG. 3A;

FIG. 3C is a perspective view of a fully assembled blade preform in accordance with an embodiment;

FIG. 3D is a partial cross-sectional view along line C-C of the fully assembled blade preform of FIG. 3C;

FIG. 3E is a perspective view of a portion of the fully assembled blade preform of FIG. 3C;

FIG. 4A is a perspective cross-sectional view of a blade preform positioned within a disassembled die cavity before introduction of a molten metal in accordance with some embodiments;

FIG. 4B is a perspective cross-sectional view of the blade preform of FIG. 4A encased in the metal and being removed from the die cavity in accordance with an embodiment;

FIG. 5A is a perspective cross-sectional view of a blade preform illustrating a final blade design to be machined in accordance with some embodiments; and

FIG. 5B is a cross-sectional view of the blade preform of FIG. 5A.

### DETAILED DESCRIPTION

While multiple embodiments are disclosed herein, still others may become apparent to one skilled in the art. In the following, certain illustrative and non-limiting embodiments are described in detail with reference to the accompanying drawings wherein like elements are designated by like numerals. It should be clearly understood that there is no intent, implied or otherwise, to limit the invention in any form or manner to that described herein. As such, all alternative embodiments are considered as falling within the spirit, scope and intent of the disclosure. The metes and bounds of the invention are defined by the appended claims and any and all equivalents thereof.

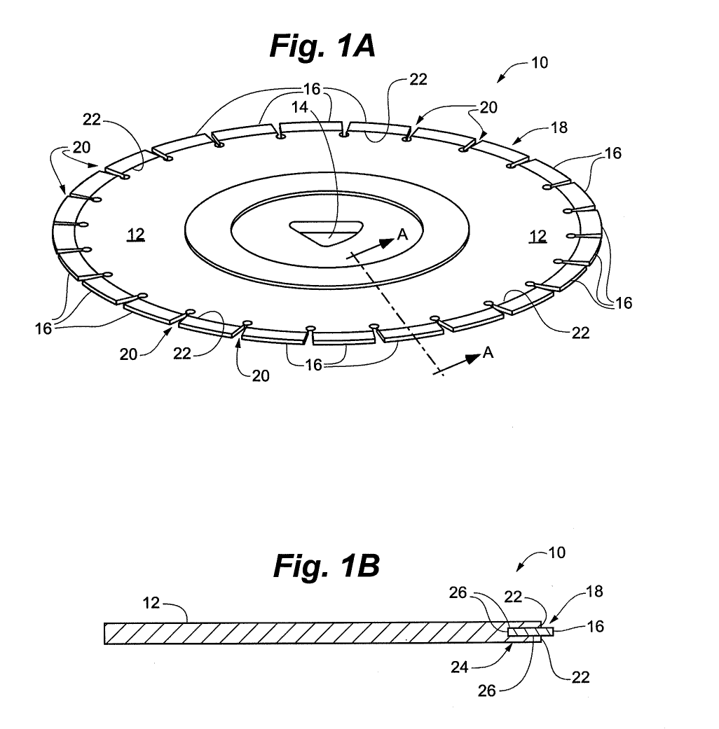

FIG. 1A is a perspective view of composite blade 10 in accordance with some embodiments, and FIG. 1B is a partial cross-sectional view along line A-A of composite blade 10 shown in FIG. 1A. Composite blade 10 includes hub segment 12 with mounting hole 14, and one or more cutting segments 16 along periphery (e.g., edge or perimeter) 18. For the circular hub segment 12 illustrated in the depicted example, the cutting segments 16 are distributed in a a circular configuration about the circular perimeter of the hub segment, though other arrangements may be possible for other geometries. According to some embodiments, adjacent segments of one or more cutting segments 16 are separated from one another by one or more recesses 20 such that the cutting segments are distributed along periphery 18 in a spaced-apart, clocked relationship. As such, one or more cutting segments 16 are generally referred to in the art as “teeth” of a cutting blade. Generally, one or more recesses 20 extend radially a short distance from periphery 18 towards mounting hole 14 at the center of composite blade 10. While one or more recesses 20 are shown as being linear and extending through one or more cutting segments 16 and into at least a portion of hub segment 12, this does not always have to be the case. For example, in some embodiments one or more recesses 20 may be shaped as a curve. In some cases one or more recesses 20 may not extend into hub segment 12 or may extend a shorter or longer distance into hub segment 12.

According to some embodiments, cutting segments 16 may be tightly distributed about the periphery without recesses 20. In some cases the recesses or other features may instead be machined into the final product. In some cases a waterjet machining process is described further herein may be used to achieve the desired configuration for the cutting segments 16.

According to some embodiments, composite blade 10 is a metal matrix composite blade having two or more segments metallurgically bonded to one another. For example, in some cases composite blade 10 includes two metallurgically bonded segments including hub segment 12 and one or more cutting segments 16 along periphery 18. As perhaps best illustrated in FIG. 1B, adjacent periphery 22 of the hub segment, hub segment 12 includes one or more recesses 24 extending into at least a portion of hub segment 12. One or more recesses 24 are configured for receiving at least a portion of one or more cutting segments 16. In some cases the recesses may be configured as slots extending along the periphery or perimeter of the hub segment. It should be appreciated though, that embodiments are not limited to one particular form of recess for receiving a portion or all of a cutting segment. As described in further detail herein below, a metal (e.g., a metal element, compound, or metal alloy) is used for forming the metallurgical bond which fixedly attaches hub segment 12 and the cutting segments 16 received within the recesses 24. In the illustrated embodiment, at least a portion of the metallurgical bond is formed along at least a portion of interface 26 between hub segment 12 and each cutting segment 16.

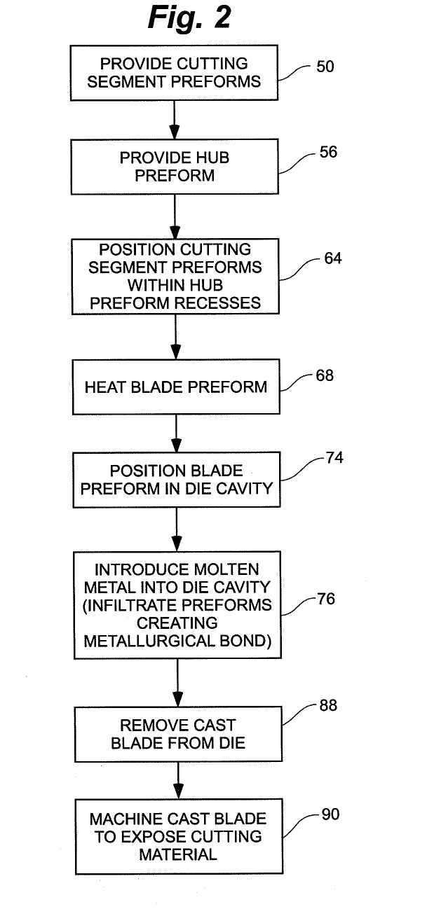

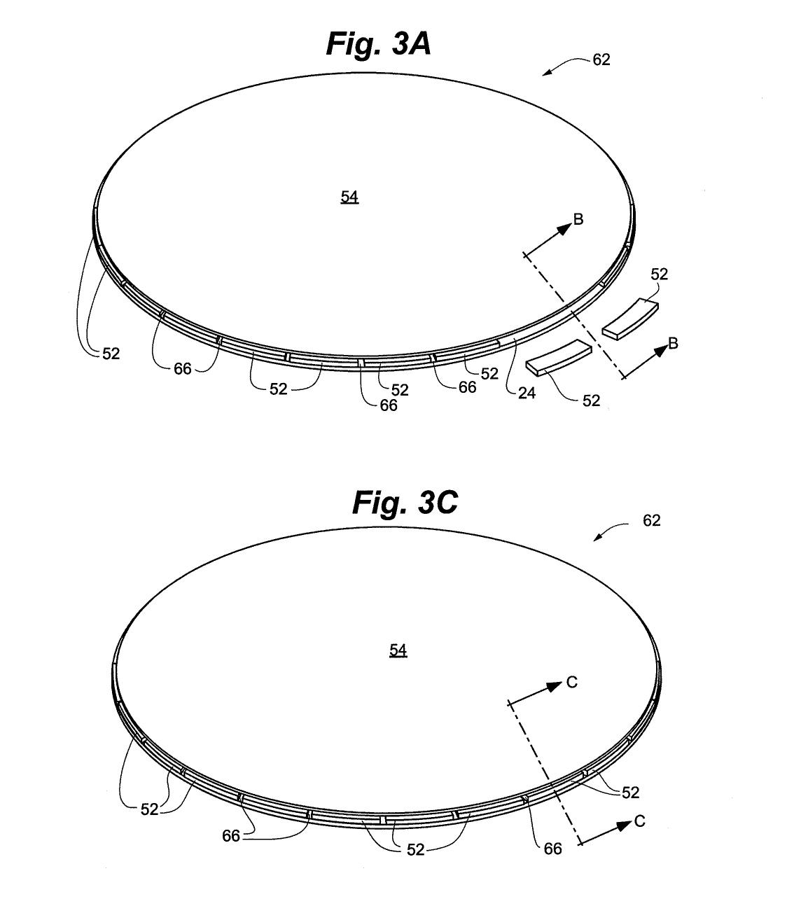

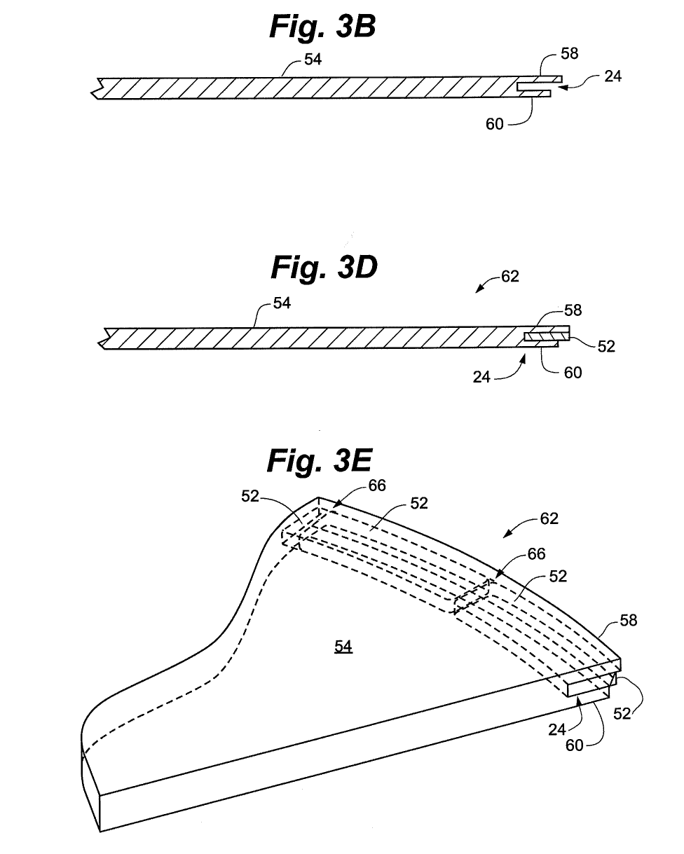

FIG. 2 illustrates a method of manufacturing a composite blade such composite blade 10 in accordance with some embodiments. The method is described herein below with reference to FIGS. 3A-5B which illustrate composite blade 10 at a few exemplary stages during manufacture.

Referring to FIGS. 2-5B, in some cases a method of manufacturing composite blade 10 starts at block 50 by providing one or more cutting segment preforms 52 and by providing hub preform 54 at block 56. In some cases, each one of one or more cutting segment preforms 52 include a cutting material and a first porous material, and hub preform 54 includes a second porous material and a reinforcing material. In some cases the cutting material includes diamonds. In some cases the reinforcing material includes fibers (e.g., ceramic fibers) and/or particles. Although not necessary, in some cases the first and the second porous materials are the same porous material or substantially similar porous materials that are hard, stiff and highly resistive to wear. Some non-limiting examples of such porous material include reinforced ceramic, ceramic material such as silicon carbide (SiC), carbon graphite, ceramic and/or non-ceramic fibers or particles, foam, or any combination thereof As such, the porosity and/or the density of the first and the second porous material, i.e., of one or more cutting segment preforms 52 and of hub preform 54, can be individually manipulated. Although not necessary, both the first and the second porous material, while composed of different substances, may yet have the same or substantially similar volume fractions and/or densities. In some embodiments, the first porous material in the cutting segment preform has a volume fraction between approximately 40% by volume and approximately 65% by volume. In some cases the second porous material in the hub preform has a volume fraction between approximately 10% by volume and approximately 50% by volume.

As illustrated in FIG. 3A, and as previously described in reference to FIGS. 1A and 1B, hub preform 54 includes at least one or more recesses 24 configured for receiving at least a portion of one or more cutting segment preforms 52. Accordingly, blade preform 62 is formed at block 64 by positioning one or more cutting segment preforms 52 within one or more recesses 24 of hub preform 54. It will be appreciated that one or more recesses 24 can be of different depth and width in different embodiments. For example, in some embodiments, such as that illustrated in FIGS. 3A and 3C, one or more recesses 24 have opposing walls of substantially equal lengths and are therefore configured for housing one or more cutting segment preforms 52 in their entirety. In some cases, such as that illustrated in FIGS. 3B and 3D, opposing walls 58 and 60 of one or more recesses 24 are of different lengths. As illustrated in FIGS. 3A, 3C and 3E, in some embodiments one or more cutting segment preforms 52 are somewhat spaced apart at locations 66 when positioned within one or more recesses 24. In some cases, though, the one or more cutting segment preforms 52 abut one another when positioned within one or more recesses 24.

In some embodiments, blade preform 62 is optionally preheated at step 68 before positioning it in die cavity 70 of die 72 at block 74, and introducing molten metal into die cavity 70, i.e., casting, at block 76. For example, in some cases blade preform 62 is preheated in an inert environment. In some embodiments preheating blade preform 62 enhances the distribution of the molten metal within the first and the second porous materials of one or more cutting segment preforms 52 and hub preform 54, respectively. In some cases, preheating blade preform 62 increases the likelihood that the molten metal is distributed efficiently and consistently within the pores of the first and the second porous materials of one or more cutting segment preforms 52 and hub preform 54, respectively. In some cases the combining the cutting segment preform inserts with the hub preform provides enhanced thermal properties for the cutting segments. For example, combining the smaller cutting segments with the larger hub segment increases the overall thermal mass of the blade preform, which enhances heat storage within both the hub preform and the cutting segment performs. Accordingly, in many cases after heating 68 the blade preform, heat will not leave the cutting segments as quickly as it might leave stand-along or separate cutting segments as used in past designs.

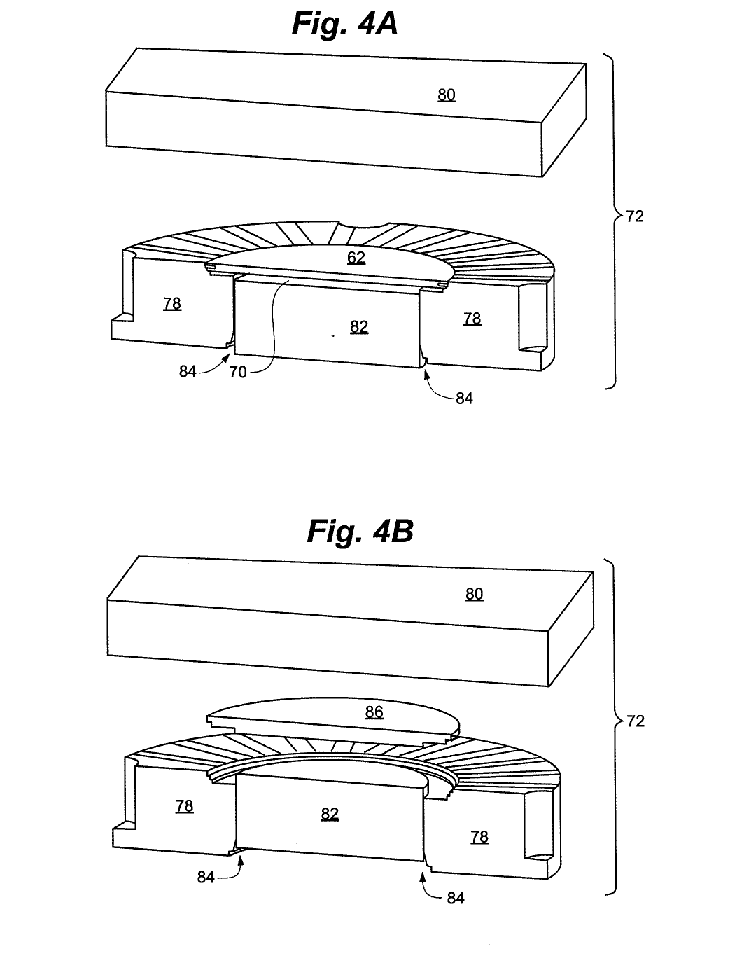

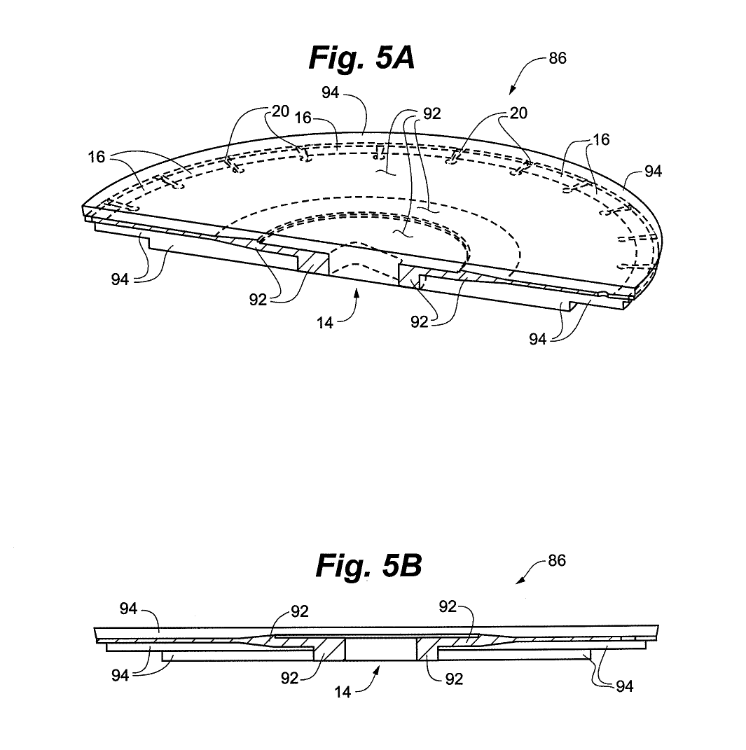

As indicated in block 76, the molten metal introduced during the casting process infiltrates the preforms creating a metallurgical bond. This process is now described with reference to FIGS. 4A and 4B which show blade preform 62 and die 72 during two steps of the casting process. As illustrated, die 72 includes first section 78, second section 80 and plunger 82 configured for extending through and for travel within shot sleeve 84 of first section 78. Die cavity 70 is at least partially defined by opposing surfaces of first and second sections 78 and 80 when positioned against one another. At the beginning of the casting process, blade preform 62 is positioned in die cavity 70 and sandwiched between first and second sections 78 and 80, respectively. Plunger 82 is retracted away from die cavity 70 (and blade preform 62) and molten metal is introduced into die cavity 70. Next, pressure is applied to the molten metal within die cavity 70 by pushing plunger 82 into die 72 towards blade preform 62 within die cavity 70. Accordingly, the molten metal penetrates through the surfaces of one or more cutting segment preforms 52 and hub preform 54, and is forced into the voids (or pores) of the first and the second porous materials. As such, when the metal cools and solidifies, it forms a metallurgical bond between hub preform 54 and the cutting segment preforms 52 within the recesses 24 of hub preform 54. As can be seen, with continued application of pressure on plunger 82, all the space surrounding and not occupied by blade preform 62 within die cavity 70, is filled by the molten metal. The metal is then permitted to cool and solidify. As illustrated in FIG. 4B, first and second sections 78 and 80 of die 72 are separated and cast 86 of blade preform 62 is removed from die 72 at step 88. Next, at block 90, cast 86 is machined into composite blade 10 as described herein below with reference to FIGS. 5A and 5B

Cast 86, when first removed from die 72, includes metal impregnated blade preform 62 encased in an outer shell of metal. FIGS. 5A and 5B respectively illustrate perspective and side cross-sectional views of cast 86 encased in metal 94 and superimposed with silhouette 92 of composite blade 10.

During machining, some or all of metal 94 and optionally some portions of metal impregnated blade preform 62 can be removed to form the final product composite blade 10 as at least partially defined by silhouette 92. In some cases, the removal of at least some portions of metal impregnated blade preform 62 may include removing at least a portion of the first and/or the second porous material. In some cases portions of the performs or porous materials may be removed in order to form the final casting into the desired predefined shape and/or in accordance with predetermined blade dimensions and specifications. According to some embodiments, making the final casting thicker (e.g., with extra metal 94 around the blade preform 62) provides flexibility for tailoring the hub geometry. For example, in some cases different types of geometry can be machined into the hub face during manufacture that may not be possible with steel blade hubs. As just a few examples, the casting may be machined to add a cooling fin or tailor the amount of heat sink material for directing heat away from the blade to a rotor core.

As one example, some portions of metal impregnated blade preform 62 may be removed for providing one or more radially extending recesses 20 along periphery 18. Additionally, or in the alternative, at least a portion of the cutting material in one or more cutting segments 16 may be exposed along periphery 18 by removing at least some portions of the first and/or the second porous material.

In certain embodiments of the invention, one or more waterjets may be used for machining purposes. For example, in some cases a waterjet (e.g., a high pressure stream of water and abrasive) is used to cut the final size and geometry of the segments and to provide relief in between the segments. In some cases the waterjetting process allows for the segment sizes to be altered, allowing minimization of segment degradation with less undercutting, and precise control of blade balance. In some cases the recesses between the segments can be optimized to avoid trapping debris in areas where it can cause wear.

According to some embodiments, the use of a waterjet in the final cutting allows for the segment sizes to be much larger. For example, the cutting segments machined by waterjetting can mimic the sizes seen in a typical finished blade. Accordingly, embodiments may not be constrained to the usual sizes for cutting segments, but can instead be made much longer to minimize handling and preform assembly issues of the segments into the hub. For example, in some cases a blade preform may only need six diamond preforms in order to fully encircle the hub preform.

In some embodiments waterjetting may also or instead be used to expose the cutting material (e.g., diamond) in the cutting segments. For example, an erosion technique can be used to expose the cutting material. The use of a waterjet is a tool that can work well for erosion techniques in some situations. According to some embodiments, aluminum and SiC particles that coat and cover diamond cutting material after the casting process need to be taken away to allow the blade to cut efficiently. In some cases a waterjet contains an abrasive that can remove such cutting material. Garnet is a typical abrasive used in commercial waterjetting and can be an effective, cost effective abrasive that can be utilized to abrade the aluminum and SiC particles away. A waterjet can also use SiC, alumina, etc. as abrasives, but the are typically more expensive and require very hard coated nozzles on the waterjet.

In some cases a waterjet used to machine the final casting is a CNC (Computer Numerical Control) controlled unit that can follow a specified pattern to direct a stream of water and abrasive at a location for a set period of time. Using this method can in some cases optimize the amount of exposure of the diamonds in a cutting segment.

In some cases the metal filling the voids of the first and the second porous material enhances the physical properties of composite blade 10. In certain embodiments, the metal is a pure metallic substance of a single composition or a metal alloy. A metal (e.g., element, compound, or alloy) having a relatively higher thermal conductivity can in some cases increase the thermal conductivity of the hub segment of composite blade 10, which can increase the rate of heat transfer from the cutting segments 16 toward a center 14 of hub segment 12 where it is further dissipated. Accordingly, in some cases the cutting segments 16 may be relatively cooler during operation that in past designs and therefore less prone to wear, and the warping propensity of composite blade 10 will be reduced. In addition to inheriting at least some thermal properties of the metal, composite blade 10 will inherit at least a portion of the structural properties generally associated with metals, such as stiffness, hardness, strength, damping capacity, etc. Accordingly, composite blade 10 can be made stronger and stiffer than non-composite blades.

As just one example, in some cases hub preform 54 comprises silicon carbide, alumina, and silica, which when infiltrated by a metal, provides a higher combined thermal conductivity than the thermal conductivity associated with hub components of past blade designs. For example, in some cases hub preform 54 is formed from a 40% SiC-2% Saffil RF milled fiber (95% Alumina-5% Silica) and infiltrated with an aluminum alloy and/or magnesium molten metal mixture. The cast stiffness for such an example can be approximated as 20 Mpsi but can be tailored to be higher or lower to improve the mechanical or vibrational characteristics of the hub segment. In some cases the ultimate strength is 45-48 Ksi.

For some materials, thermal conductivity of SiC can range from 140 W/m-K (e.g., Washington Mills Carborex RA black SiC) to 440 W/m-K (e.g., electrical grade green pure SiC). The thermal conductivity of aluminum alloy can range from 109 W/m-K (e.g., A319-T6) to 222 W/m-K (e.g., 1100-O) commercially pure aluminum. In addition, the thermal conductivity of magnesium AZ91D is about 72.76 W/m-K.

In some cases the thermal conductivity Kₚ parallel to the axis of a fiber embedded in a matrix can be estimated according to the following equation:

Kₚ=K_{f}V_{f}+(1−V_{f})Kₘ

where K_{f} is the thermal conductivity of the fiber, V_{f} is the fiber volume fraction, and Kₘ is the thermal conductivity of the fiber. Tables 1-4 below provide estimates using this equation for the combined thermal conductivity of a hub segment and a cutting segment according to various embodiments.

TABLE 1
Example 1 for Hub Segment

| Variable | Value |
|---|---|
| Fibers/Particles | Silicon Carbide |
| K_{f} | 140 W/m-K (carborex RA black) |
| V_{f} | 40% |
| Matrix | Aluminum |
| Kₘ | 109 W/m-K (A319-T6) |
| Kₚ | 121 W/m-K |

Estimate of parallel thermal conductivity in hub:
Kₚ = K_{f}V_{f} + (1 − V_{f}) Kₘ
Kₚ = 140(0.4) + (1 − 0.4) 109 = 56 + 65 = 121 W/m-K

TABLE 2
Example 2 for Hub Segment

| Variable | Value |
|---|---|
| Fibers/Particles | Silicon Carbide |
| K_{f} | 440 W/m-K (electrical grade green pure) |
| V_{f} | 40% |
| Matrix | Aluminum |
| Kₘ | 222 W/m-K (1100-O) |
| Kₚ | 309 W/m-K |

Estimate of parallel thermal conductivity in hub:
Kₚ = K_{f}V_{f} + (1 − V_{f}) Kₘ
Kₚ = 440(0.4) + (1 − 0.4)222 = 176 + 133 = 309 W/m-K

TABLE 3
Example 3 for Cutting Segment

| Variable | Value |
|---|---|
| Fibers/Particles (1) | Silicon Carbide |
| K_{f1} | 140 W/m-K (carborex RA black) |
| V_{f1} | 50% |
| Fibers/Particles (1) | Diamond |
| K_{f2} | 2100 W/m-K |
| V_{f2} | 50% |
| Matrix | Aluminum |
| Kₘ | 109 W/m-K (A319-T6) |
| Kₚ | 615 W/m-K |

Estimate of parallel thermal conductivity in cutting segment:
Kₚ = ([K_{f1}V_{f1} + (1 − V_{f1}) Kₘ] + [(K_{f2}V_{f2} + (1 − V_{f2}) Kₘ])/2
Kₚ = ([140(0.5) + (.5)109] + [2100(0.5) + (.5)109])/2 = (124.5 + 1104.5)/2 = 615 W/m-K

TABLE 4
Example 4 for Cutting Segment:

| Variable | Value |
|---|---|
| Fibers/Particles (1) | Silicon Carbide (electrical grade green pure) |
| K_{f1} | 440 W/m-K (carborex RA black) |
| V_{f1} | 50% |
| Fibers/Particles (1) | Diamond |
| K_{f2} | 2100 W/m-K |
| V_{f2} | 50% |
| Matrix | Aluminum |
| Kₘ | 222 W/m-K (1100-O) |
| Kₚ | 746 W/m-K |

Estimate of parallel thermal conductivity in cutting segment:
Kₚ = ([K_{f1}V_{f1} + (1 − V_{f1}) Kₘ] + [(K_{f2}V_{f2} + (1 − V_{f2}) Kₘ])/2
Kₚ = ([440(0.5) + (.5)222] + [2100(0.5) + (.5)222])/2 = (331 + 1161)/2 = 746 W/m-K

As can be seen from Tables 1 and 2, these two embodiments in which the hub segment includes a hub preform including silicon carbide that is infiltrated by aluminum provide a low estimate for thermal conductivity of 121 W/m-K and a high estimate for thermal conductivity of 309 W/m-K. In contrast, a typical stainless steel hub included in past saw blade designs can have a thermal conductivity closer to about 20 W/m-K. Accordingly, the effective thermal conductivity of the hub segment (e.g., as determined by the rule of mixtures) in these examples of the composite blade can provide a significantly higher thermal conductivity, thus enabling heat to be more quickly transferred away from the cutting segments of the composite blade.

Referring to Tables 3 and 4, it can be seen that for embodiments in which the cutting segment includes silicon carbide and diamond infiltrated by aluminum, the cutting segment can have an estimated thermal conductivity of between 615 W/m-K and 746 W/m-K depending upon the grade of silicon carbide and aluminum used. Comparing these values to the extremely low thermal conductivity for stainless steel (20 W/m-k) can provide some insight into the difficulties that prior blade designs incorporating stainless steel hubs have effectively removing heat generated by the cutting segments. In contrast, the depicted embodiments illustrated in Tables 1 and 2 show how a metal matrix composite hub segment can provide a thermal conductivity much closer to the conductivity of the cutting segments, thus providing more effective heat transfer away from the cutting segments.

In view of the foregoing description pertaining to the how the thermal conductivity of composite blade 10 can be affected, it will be apparent to one skilled in the art that additional, or alternative, thermal characteristics can also be easily manipulated. By way of a non-limiting example, it will be apparent that the overall thermal capacity (or thermal mass) of composite blade 10 can be manipulated to provide a desired thermal performance by manipulating the type and/or the quantity of the metal impregnating the hub segment and/or the one or more cutting segments. In some embodiments, an increase in the thermal capacity of one or more segments (hub and/or cutting) will further enhance the distribution and/or consistency of the metal impregnating the one or more segments of composite blade 10.

While composite blade 10 is illustrated and described generally as a circular blade, this should not be considered as a limitation of the disclosed invention. For example, in some cases the geometrical configuration of a composite blade could be in the form of a cylindrical coring bit or a grinding wheel. In some cases the techniques can be applied to long rope saws that are used to cut marble from quarries. In many configurations, an advantage of the composite blade structure described herein with respect to some embodiments is that all of the components of the blade (e.g., the hub segment and all cutting segments) are cast into one integrated structure in a single shot.

Various modifications may become apparent based on the above detailed description of certain non-limiting exemplary embodiments without departing from the spirit, scope and intent of the invention. For example, while the described embodiments refer to particular features and/or functions, the invention is considered to also include embodiments having combinations of features and/or functions different from those described. Accordingly, the scope and intent of the invention is intended to embrace all such alternatives, modifications, variations, etc., as may become apparent to one skilled in the art. The metes and bounds of the invention is defined by the appended claims and any and all equivalents thereof.

What is claimed is:

1. A composite blade, comprising:
one or more cutting segments; and
a hub segment comprising one or more recesses adjacent a periphery of said hub segment, wherein each one of said one or more recesses is configured for receiving at least a portion of at least one of said one or more cutting segments;
wherein, said hub segment and each one of said one or more cutting segments received within at least one of said one or more recesses are metallurgically bonded.

2. The composite blade of claim 1, wherein each one of said one or more recesses is configured as a slot extending along said periphery of said hub segment.

3. The composite blade of claim 1, wherein
each one of said one or more cutting segments comprises a cutting material and a first porous material;
said hub segment comprises a second porous material; and
said metallurgical bond is formed at least partially by a metal within each one of said one or more cutting segments and within said hub segment.

4. The composite blade of claim 3, wherein each one of said first porous material and said second porous material comprises a reinforced ceramic material.

5. The composite blade of claim 4, wherein said reinforced ceramic material comprises silicon carbide and ceramic fibers.

6. The composite blade of claim 3, wherein
said first porous material has a volume fraction between approximately 40% by volume and approximately 65% by volume; and
said second porous material has a volume fraction between approximately 10% by volume and approximately 50% by volume.

7. The composite blade of claim 3, wherein at least a portion of each one of said one or more cutting segments comprises at least one cutting edge and/or at least one cutting surface, said cutting edge and/or cutting surface defined at least partially by said cutting material.

8. The composite blade of claim 3, wherein said periphery of said hub segment comprises a circular perimeter positioning said one or more cutting segments in a circular configuration about a center of said hub segment.

9. The composite blade of claim 3, wherein the hub segment has a thermal conductivity greater than about 20 W/m-K.

10. A composite blade, comprising
a hub segment; and
one or more cutting segments along a periphery of said hub segment;
wherein said hub segment comprises a first porous material at least partially infiltrated by a metal; and
wherein said hub segment and each one of said one or more cutting segments are metallurgically bonded.

11. The composite blade of claim 10, wherein
each one of said one or more cutting segments comprises a cutting material and a second porous material at least partially infiltrated by the metal; and
said metallurgical bond is formed at least partially by the metal within said hub segment and within each one of said one or more cutting segments.

12. The composite blade of claim 11, wherein each one of said first porous material and said second porous material comprises a ceramic material.

13. The composite blade of claim 11, wherein
said first porous material has a volume fraction between approximately 40% by volume and approximately 65% by volume; and
said second porous material has a volume fraction between approximately 10% by volume and approximately 50% by volume.

14. The composite blade of claim 11, wherein at least a portion of each one of said one or more cutting segments comprises at least one cutting edge and/or at least one cutting surface, said cutting edge and/or cutting surface defined at least partially by said cutting material.

15. The composite blade of claim 11, wherein said one or more cutting segments are in a circular configuration about a center of said hub segment.

16. The composite blade of claim 11, wherein the hub segment has a thermal conductivity greater than about 20 W/m-K.

17. A method of manufacturing a composite blade, comprising
providing one or more cutting segment preforms, each cutting segment preform comprising a cutting material and a first porous material, wherein each one of said one or more cutting segment preforms at least partially defines a cutting segment of said composite blade;
providing a hub preform comprising a second porous material and one or more recesses adjacent a periphery of said hub preform, each recess configured for receiving at least a portion of each one of said one or more cutting segment preforms, said hub preform at least partially defining a hub segment of said composite blade;
positioning at least a portion of each one of said one or more cutting segment preforms within one of said one or more recesses to form a blade preform;
positioning said blade preform within a die cavity; and
introducing a molten metal into said die cavity to at least partially infiltrate said hub preform and to at least partially infiltrate each one of said one or more cutting segment performs, thereby creating a metallurgical bond between at least a portion of said hub segment and at least said portion of each one of said one or more cutting segments.

18. The method of claim 17, further comprising heating said blade preform before positioning said blade preform within said die cavity.

19. The method of claim 17, further comprising machining said blade preform, said
machining comprising at least partially exposing said cutting material in at least a portion of said cutting segment of said composite blade; and
at least partially defining at least one cutting edge and/or at least one cutting surface.

20. The method of claim 17, wherein
said first porous material has a volume fraction between approximately 40% by volume and approximately 65% by volume; and
said second porous material has a volume fraction between approximately 10% by volume and approximately 50% by volume; and
at least a portion of said composite blade has a thermal conductivity greater than about 20 W/m-K.
